(19) United States
(12) Patent Application Publication
(10) Pub. No.: US 2023/0217969 A1
(43) Pub. Date: Jul. 13, 2023

(54) APPARATUS AND METHOD FOR STEAM FRYING FOOD SNACK PIECES

(71) Applicant: Anders Fredlund, Bjärred (SE)

(72) Inventor: Anders Fredlund, Bjärred (SE)

(21) Appl. No.: 18/007,523

(22) PCT Filed: Jun. 3, 2021
(86) PCT No.: PCT/SE2021/050524

§ 371 Date: Dec. 1, 2022

(30) Foreign Application Priority Data
Jun. 8, 2020 (SE) 2030190-9

(51) Int. Cl. A23L 5/10; A23L 19/18; B65G 33/08

(52) U.S. Cl. CPC A23L 5/13; A23L 5/12; A23L 5/15; A23L 19/18; B65G 33/08; B65G 2201/0202

(57) ABSTRACT

An apparatus and method for continuously at atmospheric pressure rotary steam fry potato slices, the apparatus comprising an inlet conveyer for taking the slices from a lower atmospherically opened inlet into a rotary conveyor with steam permeable mantle surface for tumbling and conveying potato slices inside a hermetically closed top through a pre heat zone and a frying zone until gravity fed out through an atmospherically opened outlet below the hermetically closed top, an oiler for totally covering the slices with oil before entering the frying zone, a loop heating system consisting of at least one separator, one gas blower and one heat exchanger adapted for pushing superheated stem, with temperature of 110 to 300 C, through the conveyor with steam permeable mantle surface and through a deep bed of potato slices, heating the oil on the potato slices surface which in tum heats the potato slices.

### FIELD OF INNOVATION

This invention relates to an apparatus and method for rotary steam fry food snack pieces.

### BACKGROUND OF THE INVENTION

Deep fryers are widely used in the snack industry for cooking food snack pieces in hot oil. When food snack pieces, such as potato chips, are fully cooked and taken out of the hot oil there is usually a lot of oil on the surfaces of the snack pieces. It is well known that as snack pieces cool, steam inside the food snack pieces will condensate, and create an under pressure that will pull a large portion of surface oil into the snacks. Deep fried potato chips typical end up with an oil content of 30 to 35%. Excessive amount of oil in potato chips and other food snack pieces is an unwanted feature for many consumers.

SE397256 to Joensson et al describes an approach to lower the oil in potato chips by blowing off some of the surface oil with steam at high speed in conjunction with uptake of the potato chips from a deep fryer, while temperature in the chips is over 100 C. The chips still end up with about 20% fat.

Another approach to lower the fat content has been to bake potato slices. EP2438820 in the name of Intersnacks Group and Heat and control claims a rotary air impingement oven for oil-free producing dehydrated potato chips, comprising mixing part of the vapor with burner heated gas and air and then impinging the mixture through the product bed,

Totally fat free potato chips have not reached any larger commercial footprint. WO2012104215 to Spurr et al teaches that the consumer demand that potato chips that looks, feels and taste like deep fried chips and further teach that adding 7-13% oil to sliced potatoes and then heat them with microwaves and hot air will create a similar mouthfeel, texture and look as deep fried chips. They suggest a first dipping of the potato slices in 90 C oil for about 90 seconds and then cleaning them with water and air jets. In WO 2012104217 to Spurr et al describes that it is desirable to first pre-dry oiled potato slices overlapping in a microwave oven and then dry the slices in a rotary microwave oven but face a problem of clumping of potato slices. Spurr et al claim a separating devise of potato slices after the pre-dry and before being tumbled.

US3934545 to Schady et al claims an apparatus for enrobing discrete objects comprising a perforated rotatable drum, spraying a coating and simultaneously drying the coating with conditioned air, directed through the drum and product bed. Exhausted air is cleaned from particles in a centrifugal separator and can be partly mixed again with the tempered air.

Heating oil with high temperature air should be avoided as it leads to oxidation of the oil. Oil oxidation is an undesirable series of chemical reactions involving oxygen that degrades the quality of the oil. Oxidation eventually produces rancidity in oil, with accompanying off flavors and smells and shortening of shelf life.

Another problem with in air-based drying systems is the formation of explosive mixture of oxygen, oil mist and whirled up dust. To minimize the risk of explosion it often require complex and cost intensive construction and operation as for example extensive venting, pressure protection systems, fire extinguishing system and use of inert gas in process.

There is a long felt need for an apparatus to fry food snack pieces without the heavy uptake of fat as deep frying means.

### SUMMARY OF THE INVENTION

It is an object of the present invention to fill a long felt need by providing an apparatus and method for making fried food snack products with long shelf life, in a high throughput manner, without the heavy oil uptake that deep frying result in. In particular the invention relates to an apparatus and method for steam frying potato slices.

This object is achieved by an apparatus according to claim 1 and a method according to claim 6. According to the present invention, an apparatus for continuously rotary steam fry potato slices at atmospheric pressure comprising: a hermetically closed top, when in running is filled with oxygen free gas and steam; an atmospherically opened inlet and an atmospherically opened outlet below the hermetically closed top; an open ended tubular rotatable conveyor with gas permeable mantle surface inside the hermetically closed top; a loop heating system consisting of at least one separator, one gas blower and one heat exchanger when in running is pushing superheated steam of 110 to 300 C through the conveyor gas permeable side wall and through the product bed and forming a preheating and a frying zone and then back to the separator; one or a plurality of oilers arranged in such way that for the food snack pieces surfaces are totally covered with oil before the products entering the frying zone, wherein the superheated steam in the frying zone is heating the food products surface oil, which in turn conductional heats the food snacks pieces. a conveyor to convey food pieces from the inlet into the hermetically closed top and arranged in such way that food snack pieces are transmitted into the tubular conveyor;

A method of steam frying potato slices carried in a rotary steam permeable conveyor, the method comprising the steps of:
(a) providing an input flow of potato slices whose surface is completely covered with oil into a frying section of a rotary conveyor with steam permeable mantle surface inside a hermetically closed top with atmospherically opened inlet and an atmospherically opened outlet below the hermetically closed top
(b) Pushing superheated stem, with temperature of 110 to 300 C, through the rotary conveyor with steam permeable mantle surface and through a deep bed of potato slices heating the oil on the potato slices which in turn conductional heats the potato slices; created by a loop heating system consisting of at least one separator, one gas blower and one heat exchanger; while the slices are being tumbled and conveyed forward

The apparatus and method of the present invention is suitable for steam frying food snacks pieces of a variety of raw materials. Food pieces may include potato, sweet potato, parsnip, beetroot, avocado, zucchini, pineapple, apple, or any fruit or vegetable that can be eaten as snacks in a dried state. Food pieces can be made from dough that are formed to pieces or sheeted, rolled and cut may be used, as for example nachos. The apparatus and method may also be used for extruded food pieces including pellets or direct expanded. The present invention may also be used for popcorn or peanuts and other nuts. The present innovation is suitable for any food piece that is gaining of a being steam fried.

The apparatus and method of the present innovation is especially adopted for steam frying potato slices Standard industrial steps of preparation of raw slices is preferable and may include steps of destoning and washing of potatoes, scrubbing or peeling, pulse electric field treatment, slicing, washing of excess starch from slices and chemical treatment. One standard pulsed electric field (PEF) setting when treating 1500 kg an hour of potatoes is 0.4 to 1.4 kJ per kilo slices and could go as high as 20 kJ per kg. The PEF could be done with any commercially available equipment as from for example Kea-Tec or Scandinova and setting ranges of voltage of 0-30 kV, current range of 0-700 A, pulse repetition frequency of 0-500 Hz and pulse length of 0.5-10 micro s. The potatoes are preferably sliced to 0.4-3 mm thick but more preferable 1.0 to 2.2 mm thick. In the washing of slices 0.1 to 3% of salts can be used. Even though the pulsed electric field treatment makes a smoother cut there are usually some broken cells with trapped starches. As slices are heated the starches can swell and get sticky and therefore it can be advisable to use starch dissolving enzymes in the washing step; selected from the group consisting of an amyloglucosidase, glucose oxidase, laccase, lipase, maltogenic amylase, alfa,, beta, or gamma amylase, pectinase, pentosanase, protease, and transglutaminase; wax or emulsifiers that reduce or totally counteracts stickiness.

In an exemplifying embodiment of the present invention an input flow was set to 970 kg per hour of 1.5 mm potato slices, rotational speed of a 4560 mm long and 1200 mm diameter tubular rotatable conveyor with steam permeable sides was set to 2 rpm, preheating superheated steam temperature was set to 180 C and speed through product bed 5.5 m/s, oiler was set to 10% oil in final product, frying superheated steam temperature was set to 148 C and steam speed through product bed 2.5 m/s. The running yield 225 kg, 10% oil fried potato chips.

To speed up the frying and decrease the frying time an apparatus of the present invention further comprise at least one infrared heater in the frying zone. It is preferable that the infrared heater doesn’t leave exhaust gases in the hermetically closed top. Any commercial heater could be used as for example halogen quartzglas heaters, lamps of medium or long wavelength, electrical ceramic heaters, SER burners or electrical metal heaters All above heaters can increase frying speed but with differentiated efficiency and power density and the wavelengths can be chosen from product to be fried and therefore vary between 550 to 12000 nm.

In an exemplifying embodiment of the present invention an input flow was set to 1455 kg per hour of 1.5 mm potato slices, rotational speed of a 4560 mm long and 1200 mm diameter tubular rotatable conveyor with steam permeable sides was set to 3 rpm, preheating superheated steam temperature was set to 180 C and speed through product bed 5.5 m/s, sprayers were set to 10% oil in final product, frying superheated steam temperature was set to 148 C and steam speed through product bed 2.5 m/s, a halogen heater unit was put to 2 kW per inlet kg for last third of the process. The running yield 340 kg/h of fried potato chips.

The present inventor have found that by steam fried potato chips are almost identical with deep fried potato chips with the difference that steam fried pieces consist of less oil. A thin layer of oil on the potato slices surface will be enough for create a frying. An oiling within the tubular steam permeable tube enable an even and low oil coverage of the food snack pieces and the steam inhibited risk of oxidation of oil and risk of explosions. A further advantage of the apparatus is that energy is not needed to be vented out of the system and can be used by letting excess steam out of a discharger and used in other parts of the process and making the system highly energy effective.

The rotary conveyor with steam permeable mantle surface wherein the slices being steam fried could have a diameter of 300 to 3000 mm and length of 800 to 25000 mm. The steam permeable sidewall can be made of metal mesh, net, grid, perforated metal or other food grade and heat and steam stable material that is steam permeable. The feeding system of the rotatable conveyor consist of internal stationery helically screw, an internal screw with step feeding flights or with internal stationary blades arranged in angels for pushing the products in longitudinal movement or by tilting the rotary tubular conveyor and let gravity feed snack food pieces in every turn. In an alternative embodiment the tubular rotatable conveyor can be divided into two or more communicating conveyors that could work at different rotatable speeds.

The loop heating system blowing superheated steam through the product bed can be made of a first separator such as a baffle , centrifugal, filter, coalescer filter, motorized high speed disc stack separator or combinations thereof, a second gas blower as an axial fan, radial fan or a jet blower and a third heat exchanger using heated gas, thermal oil, induction or electrical heat for heating the steam.

The oiling of the food snack pieces as potato slices could be made by a hydraulic spray, compressed gas spray, a bakery spinning plate oiler or a vertical oil curtain. The oiler is preferable placed inside the rotary conveyor with steam permeable mantle surface in the preheat step. The important is to get an even coating of the surface before the frying zone. This can easily be achieved as slices are tumbled in the pre heat zone. If a compressed gas spray would be used it is preferable that the gas is oxygen free, for example steam. In alternative embodiment the coating of oil could be done before the frying zone by dipping the snacks in vessel filled with cold or hot oil or oil emulsion or oiling a seasoning drum or coating drum prior to conveying the slices into the preheat zone. Additional oilers could also be placed throughout the frying zone if the apparatus is run with such steam speed that part of the surface oil is blown off the food snack pieces while frying.

It is unwanted with oxygen in the hermetically closed top when running the apparatus as it will oxidize the frying oil. A preferable procedure before starting an apparatus of the present invention is to empty the hermetically closed top from oxygen. In an exemplifying embodiment of the present invention a pipe with valve is installed to the top of the hermetically closed top and a gas tub with lighter gas than oxygen is connected. The valve is opened and filling the hermetically closed top with light gas until all oxygen is pressed out of the top through the bottom openings, and the valve is closed again. It is possible to combine with for example burning gases or high pressure steam flushing. Another alternative would be to just letting the first production run until all oxygen has reacted..

When the steam fryer is running, steam from frying snack food pieces will evaporate. A further preferable feature of an apparatus of the present invention is to connect a discharger for excess steam. It could preferably be connected close to the outlet or inlet. Thereby the discharger will create a controllable stratification layer between phases of steam in the upper hermetically closed top and ambient air. The discharger also enables to use energy in the excess steam. If the excess steam is not directly used in other parts of the process it can be preferable to connect a condenser or heat exchanger to harness the energy.

It is obvious for one skilled in the art that food snack pieces can be fried in other substances than ordinary frying oil can be fully or partly used as for example wax, Olestra™, lard, fat, fat replacers, sucrose polyesters, medium chain fatty acids or other lipophilic substances or mixing chemicals into the frying media. It is also obvious that the apparatus and method of the present invention is not changed due to different earlier steps of pretreatment of the food pieces or further processing steps.

It is also obvious to one skilled in the art, given the outline of this invention, that sizing and choice of components and their fine-tuning can be changed and considered as standard technical design works. The apparatus and the components are scalable, and can be employed for various mass flow rates of products there through.

The novel features of the present innovation will be further discussed by the drawings and detailed descriptions. It should be understood that the drawings are for illustration and descriptions are not intended to as definition of the limits of the present innovation.

### BRIEF DESCRIPTION OF THE DRAWINGS

The drawing in FIGS. 1 to 6 describe one embodiment and method of an exemplifying apparatus for rotary steam fry food snack pieces.

FIG. 1 is a schematic side view of an embodiment of the exemplifying apparatus for steam frying food snack pieces

FIG. 2 is a schematic side view section of a tubular rotary conveyor with an internal screw with step feeding flights used in the exemplifying apparatus for steam frying food snack pieces

FIG. 3 is an enlarge section of FIG. 2

FIG. 4 is an enlarge transverse cross section of a driving of a tubular rotary conveyor of FIG. 2

FIG. 5 is transverse cross section diagrammatic view of the exemplifying apparatus for steam frying food snack pieces with a loop heating system.

FIG. 6 is a perspective view of the loop heating system and the tubular rotary conveyor with an internal screw with step feeding flights.

### DETAILED DESCRIPTION

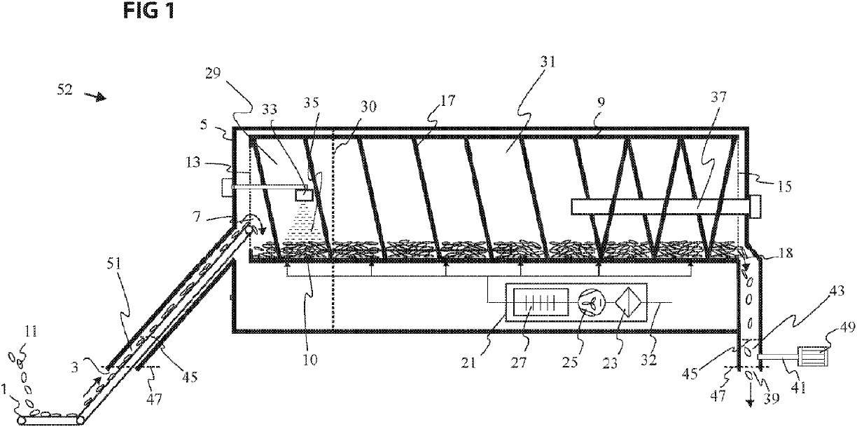

FIGS. 1, 2, 3, 4, 5 and 6 disclose an outline of an exemplifying embodiment of an apparatus and method according to the present invention. It should be noted that same reference signs throughout the accompanying drawings refer to same of like components.

FIG. 1 is a schematic side view of an exemplifying embodiment of an apparatus according to the present invention for steam frying food snack pieces. A primary endless belt conveyor 1 having an elongate longitudinal and upward direction for conveying food pieces through a bottom inlet 3 into a hermetically closed steam filled top 5. The primary conveyor 1 is communicating incoming of potato slices 11, in this case 1.5 mm. The first conveyor 1 is made endless stainless steel wire mesh conveyor arranged in such way that the potato slices fall by gravity 7 into a tubular rotatable conveyor 9 forming a deep bed of potato slices 10.

The tubular rotatable conveyor 9 has an open end inlet 13 and an open end outlet 15 and gas permeable sidewall. As the tubular rotatable conveyor 9 turns the deep bed of potato slices 10 will be tumbled and fed forward through an internal stationary feeding system 17 feeding the product forward from inlet end 13 to outlet end 15 where the food pieses 10 are fed out 18 and fried potato chips can by gravity be fed out through the bottom outlet 39.

A loop heating system 21 consisting of a separators 23, a gas blower 25 and a heat exchanger 27 when in running is pushing superheated steam of 110 to 300 C through the conveyor gas permeable side wall and through the product bed and forming a preheating zone 29 and a frying zone 31 and then led back 32 to the separator 23. The preheating zone 29 is characterized by initially heating the potato slices by conduction through condensing water. The frying zone 31 is characterized by heating the potato slices by conduction of hot oil and that oil is in turn heated by the loop heating system 21. The separator 23 is an inline centrifugal separator, the gas blower 25 is a radial fan and the heat exchanger is a thermal oil heat exchanger and the steam flow is set between 1 and 20 m/s.

An oiler 33, a hydraulic spray system, arranged in such way that for the food snack pieces surfaces are totally covered with oil 35 before the products entering the frying zone 31

An infrared heater 37 a rack of halogen quartzglas heaters with internal gold reflectors is used, each tube with a power of 1000 W and emit a peak wavelength of 1100 nm and a color of 1012 K, and of full rack capacity of 120 kW when set on full power to speed up the frying and shortening the process time.

A discharger 41 of excess steam is connected close to the outlet 39, creating a controllable stratification layer 43 between phases of steam 45 in the upper hermetically closed top 5 and ambient air 47. The excess steam can be vented, directly used or in this case connected to a condenser 49. The discharge of excess steam in one end will on infeed side, by gravity, form an equal horizontal located stratification zone 51. A discharger 41 enable an even and controllable steam travel over the boarder 30 between the frying zone 31 and preheat zone 29 and giving the apparatus; the steam fryer 52 four clearly divided zones 51,29,31,43.

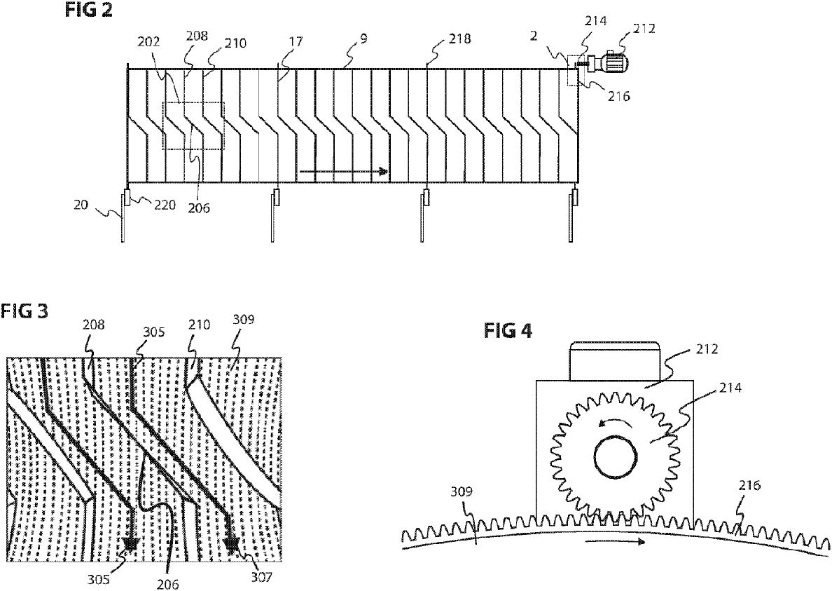

FIG. 2 is a schematic side view section of the tubular rotary steam permeable conveyor with an internal screw with step feeding flights. One section 202 is framed showing a step feeding flights arrangement and can be seen as a close-up in FIG. 3. Another section 204 is also framed showing a driving of a tubular rotary conveyor and can be seen as a 90 degree horizontal turned close-up in FIG. 4. The three figures together comprising:

The feeding system 17 of the tubular rotatable conveyor 9 consisting of an internal screw with step feeding flights 206. The screw consist of large section of vertical oriented c formed blade 208 followed by a shorter an angled flight 206 per lap connected to a new vertical oriented c formed blade 210 and new a shorter an angled flight and so repeated for the entire length of the inner mantle surface of the tubular rotary steam permeable conveyor . The screw’s sections between the vertical oriented c formed blades will counteract horizontal movement between two vertical segments and the flighted segment 206 will push the slices from one section 305 into a new vertical segment 307. The screw has a total of 24 flighted segments and will take 24 revolutions to feed the potato slices from inlet to outlet. A motor 212 make the tubular rotary conveyor 9 and internal feeding screw 17 to rotatable by a driving gear 214 on the motor and an attached gear 216 on the conveyor. The tubular rotary steam permeable conveyor 9 has ring formed flanges 218 on the outside of the tube which are resting on wheels 220.

A steam permeable sidewall 309 of steam permeable conveyor is made of expanded metal mesh of stainless steel, with mesh size of 8 times 6 mm. The steam permeable sidewall 309, the feeding system 17, ring formed flanges 218 welded together to constitute one piece of tubular rotary steam permeable conveyor 9.

FIG. 5 is transverse cross section diagrammatic view of the apparatus for steam frying food snack pieces. The loop heating system with a fan 25 pushing steam into a tapered channel 501 forcing the steam through a heat exchanger 27 for superheating. The illustrated heat exchanger is a thermal oil heat exchanger of 600 mm in high, 760 mm in both width and depth made of 18 mm diameter 304 stainless steel with aluminum fins. Hot thermal oil is pumped into an inlet flange 503 passing 14 rows and 12 layer of pipes until led out from an outlet flange 505. Any commercial available thermal oil heating unit with oil pumping system could be used, as for example a unit from Heiza Werkstätten Wärmetechnik GmbH.

Superheated steam is then pushed through the permeable conveyor 9 and product bed 10 directed by closed framing plates 507. The steam continuous to a separator 23. In the illustrated embodiment an inline centrifugal separator is used. Stationary jet blades 509 direct the steam into a circular tube which cause the steam to circulate 511. Heavier particles will be centrifuged to first the inner walls of the tube then fall down through a permeable holed plate 513 and solid particles, oil 517 and water 519 can be led out by a pipe 515. The steam will then be recirculated by the fan 25.

The oiler 33 with a directed oil flow 35 for total coverage of the food snack pieces 10, in this case a hydraulic spray system, PulsJet, from Spaying System Co is used, with a flat nozzle creating an oil curtain. The PulsaJet can provide a very controllable flowrate of oil by pulsing the oil, with up to 25000 cycles per minute and regulate the oil flow from 10 to 100% and 0.2 to 60 liters per hour.

An upper pipe with valve 521 to empty hermetically closed top from oxygen by introducing lighter by open for connected hydrogen or helium gas starting up the steam fryer . A bottom valve 523 can simultaneously be opened to lead out the sinking air with oxygen. When the hermetically closed top 5 is emptied from oxygen air the valves are closed and the steam fryer is preferable preheated to 120 C. The upper valve 521 can then be opened again for flushing connected steam for a period of time until a part of the oxygen free gas is replaced with steam. The valve 521 is then closed. Any commercial available connecting gas tubes, steam boiler and piping could be used.

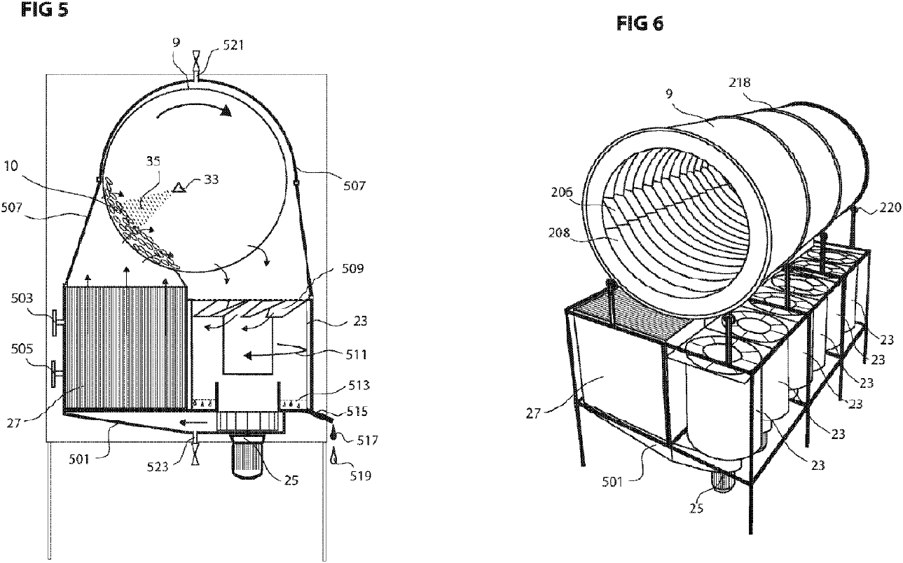

FIG. 6 is a perspective view of the heating system and the feeding screw. Outer plates and directional plates, oiler and the inlet conveyor is lifted away. In the illustrated embodiment six inline separators 23 are seen but only part of the fans 25, tapered channels 501 and heat exchangers 27 are seen. It should be understood that there are six communicating gas blowers 25, six communicating tapered channels 501 and six communicating heat exchangers 27. There are four wheels 220 seen on one side of the tubular rotary steam permeable conveyor 9 with an internal screw consist of large section of vertical oriented c formed blade 208 then a shorter an angled flight 206. It should be understood that there equal pair of wheels 220 not seen, in total 8, where the welded flanges 218 are uphold by and the rotating against.

1-9. (canceled)

10. An apparatus for continuously rotary steam frying food snack pieces at atmospheric pressure, said apparatus comprising:
a hermetically closed top, when in running is filled with oxygen free gas and steam;
an atmospherically opened inlet and
an atmospherically opened outlet below the hermetically closed top;
an open ended tubular rotatable conveyor with gas permeable mantle surface inside the hermetically closed top;
a loop heating system consisting of at least one separator,
one gas blower and one heat exchanger when in running is pushing superheated steam of 110 to 300° C. through the conveyor gas permeable side wall and through the product bed and forming a preheating zone and a frying zone and then back to the separator;
one or a plurality of oilers arranged in such way that for the food snack pieces surfaces are totally covered with oil before the products entering the frying zone,
wherein the superheated steam in the frying zone is heating the food products surface oil, which in turn heats the food snacks pieces
a conveyor to convey food pieces from the inlet into the hermetically closed top and arranged in such way that food snack pieces are transmitted into the tubular conveyor.

11. The apparatus according to claim 1, wherein the tubular rotatable steam permeable conveyor has an internal step feeding screw constituted of vertical oriented c-formed blades followed by shorter angled flights repeated for the entire length of the inner steam permeable mantle surface of the tubular rotary conveyor.

12. The apparatus according to claim 1, wherein the oiler is placed for operating in the preheat zone.

13. The apparatus according to claim 1, wherein the tubular rotatable conveyor is divided into two or more communicating conveyors that can work at different rotatable speeds.

14. The apparatus according to claim 1, further comprising at least one infrared heater in the frying zone that does not leave exhaust gases in the hermetically closed top and emitts wavelengths of 550 to 12000 nm.

15. A method of steam frying food snack pieces carried in a rotary steam permeable conveyor, the method comprising the steps of:
providing an input flow of food snack pieces, the surfaces of which are completely covered with oil, into a frying section of a rotary conveyor comprising a steam permeable mantle surface inside a hermetically closed top, an atmospherically opened inlet, and an atmospherically opened outlet below the hermetically closed top and
pushing superheated steam having a temperature of 110 to 300° C. through said rotary conveyor and through a deep bed of food snack pieces, thereby heating the oil on said snack pieces which, in turn, heats said food snack pieces by conduction;
wherein said superheated steam is created by a loop heating system consisting of at least one separator, one gas blower, and one heat exchanger and
wherein said food snack pieces are being tumbled and conveyed forward.

16. The method according to claim 15, wherein said food snack pieces are oiled inside said rotary conveyor.

17. The method according to claim 15, further comprising heating said food snack pieces simultaneously with infrared heaters emitting wavelengths of 550 to 12000 nm, wherein said heating does not leave exhaust gases in the hermetically closed top.

18. The method according to claim 15, wherein said food snack pieces are potato slices.
